(19) United States
(12) Patent Application Publication
(10) Pub. No.: US 2021/0354554 A1
(43) Pub. Date: Nov. 18, 2021

(54) MODULAR FUEL TANK FOR MOTOR VEHICLE

(71) Applicant: PSA AUTOMOBILES SA, Poissy (FR)

(72) Inventors: Germain CONVERS, Champagney (FR); Romain DERUELLE, Berche (FR); Frederic JOLIVET, Eglingen (FR); David SAILLARD, Dole (FR)

(21) Appl. No.: 17/294,609

(22) PCT Filed: Oct. 16, 2019
(86) PCT No.: PCT/FR2019/052447

§ 371 Date: May 17, 2021

(30) Foreign Application Priority Data
Nov. 23, 2018 (FR) 1871762

(51) Int. Cl. B60K 15/04; B60K 15/03; B60R 16/02; F01N 3/20; B01D 53/04; B01D 53/94

(52) U.S. Cl. CPC B60K 15/04; B60K 15/03177; B60R 16/0207; F01N 3/2066; B01D 53/0446; B01D 53/9431; B01D 2259/4516; B60K 2015/03256; F01N 2610/1406; B60K 2015/03493; B60K 2015/03309; F01N 2610/1433; B60K 2015/03236

(57) ABSTRACT

The invention relates mainly to a fuel tank (10) that can be adapted to several types of motor vehicle engines, comprising: —a casing (11) defining a fuel filling space, —a fuel filler pipe (12), and —a gauge/pump module (13), characterized in that the casing (11) has a shape that is suitable for covering different types of gasoline and diesel engines, and in that the casing (11) comprises passages (15) for routing and holding pipes and/or wiring harnesses, the passages (15) formed in advance in the casing (11) being capable of covering routes for pipes and/or wiring harnesses of different types of gasoline and diesel engines, such that some passages (15) used for the pipes and/or wiring harnesses of a given engine are present for an engine of another type but not used.

### CROSS-REFERENCE TO RELATED APPLICATIONS

This application is the US National Stage under 35 USC § 371 of International Application No. PCT/FR2019/052447, filed 10 Oct. 2019 which claims priority to French Application No. 1871762 filed 23 Nov. 2018, both of which are incorporated herein by reference.

### BACKGROUND

The present invention relates to a modular fuel tank for a motor vehicle. The fuel tank is used particularly advantageously with motor vehicles equipped with any type of diesel or gasoline combustion engine.

In a manner known per se, a fuel tank comprises a casing produced from a plastic material, in particular by means of a blow-molding process, defining a fuel filling space. A fuel filler pipe proceeds from the tank and terminates near an opening provided in an external panel of the body. A filler flap housing arranged in the opening of the panel is designed to receive the end of the filler pipe. A gauge-pump module makes it possible to provide an indication of the quantity of the contents of the tank and to supply the injection system of the combustion engine with fuel. The tank is intended to be secured to the body of the vehicle via suitable securing means consisting, in particular, of straps having through-holes for securing members proceeding from the body of the vehicle, such as studs.

The tank further comprises passages for routing and holding pipes and wiring harnesses, such as a pipe extending from the gauge-pump module to the combustion engine, a pipe extending from a vapor absorption device to the combustion engine, harnesses to the rear axle, a harness for supplying an additional heating unit, a harness for supplying a leak diagnosis module of the vapor absorption device, etc.

However, there is a wide variety of tank casing designs associated with the various emission standards, such as standards €5, €6, €6.1, €6.2, etc., with the different types of diesel or gasoline engines, as well as with the various tank suppliers.

Simplifying the tank is difficult due to the lack of centralization of information from the design teams for the different tanks, the difficulty of combining all the installation constraints, the delay in the launch schedules of the various vehicles, as well as the fact that, historically, the task of routing wiring harnesses and pipes on the tank was delegated to the supplier of the tank.

### SUMMARY

The invention aims to effectively remedy these drawbacks by proposing a fuel tank that can be adapted to several types of motor vehicle engines, comprising:
a casing defining a fuel filling space,
a fuel filler pipe, and
a gauge-pump module,
   wherein the casing has a shape that is suitable for covering different types of gasoline and diesel engines, and
   wherein the casing comprises passages for routing and holding pipes and/or wiring harnesses, the passages formed in advance in the casing (i.e., being preformed in the casing) and being capable of covering routes for pipes and/or wiring harnesses of different types of gasoline and diesel engines, such that some passages used for the pipes and/or wiring harnesses of a given engine are present for an engine of another type but not used.

The fuel tank design enable the integration of all divergent elements in order to obtain a tank that is compatible with all motor vehicle engines. The fuel tank makes it possible to avoid differing installation volumes, which would require differing routes for pipes and wiring harnesses. The fuel tank also makes it possible to guarantee interchangeability of the tanks and components throughout the world. It is also possible to easily have multiple sources of supply in order to avoid any interruptions to the manufacture of motor vehicles in the event of a production problem in a factory.

According to one embodiment, the tank further comprises securing zones for securing added functional modules, so as to be able to select, if necessary, added functional modules depending on the type of engine of the motor vehicle.

According to one embodiment, the added functional module or modules of the tank are chosen from among the following functional modules: a diesel additive tank, a diesel filter, a gasoline filter, a fuel vapor absorber, valves.

According to one embodiment, the securing zones dedicated to the functional modules of a given engine are compatible with the functional modules of another engine.

According to one embodiment, in order to be compatible with a gasoline engine, the tank comprises passages for routing and holding all or some of the following pipes and wiring harnesses: rear axle harnesses, a pipe and a harness for supplying an additional heating unit, a pipe extending from the gauge-pump module to a combustion engine, a pipe extending from a vapor absorption device to the combustion engine, a fuel pipe supplying a gasoline filter, a harness for supplying a leak diagnosis module of the vapor absorption device.

According to one embodiment, in order to be compatible with a diesel engine, the tank comprises passages for routing and holding all or some of the following pipes and wiring harnesses: rear axle harnesses, a pipe and a harness for supplying an additional heating unit, a pipe extending from the gauge-pump module to a combustion engine, a pipe extending from a vapor absorption device to the combustion engine, a fuel pipe supplying a diesel filter, a diesel exhaust fluid pipe and a harness for supplying a pump of a selective catalytic reduction system, a harness of an exhaust probe for detecting nitrogen oxide pollutants, a harness for a soot detection probe.

According to one embodiment, the casing is made of a blow-molded plastic material.

The invention also relates to a motor vehicle that comprises a fuel tank as defined above.

### DESCRIPTION OF THE DRAWINGS

FIG. 1 is a perspective view of a fuel tank;

FIG. 2a is a plan view of a fuel tank intended for use with a first type of gasoline engine;

FIG. 2b is a plan view of a fuel tank intended for use with a second type of gasoline engine;

FIG. 2c is a plan view of a fuel tank intended for use with a third type of gasoline engine;

FIG. 2d is a plan view of a fuel tank intended for use with a fourth type of gasoline engine;

FIG. 3a is a plan view of a fuel tank intended for use with a first type of diesel engine;

FIG. 3b is a plan view of a fuel tank intended for use with a second type of diesel engine;

FIG. 3c is a plan view of a fuel tank intended for use with a third type of diesel engine;

FIG. 3d is a plan view of a fuel tank intended for use with a fourth type of diesel engine;

FIG. 3e is a plan view of a fuel tank intended for use with a fifth type of diesel engine;

FIG. 4 is a plan view of a fuel tank provided with a valve for absorbing vapors during filling.

Identical, similar, or analogous elements have the same reference sign across all figures.

### DETAILED DESCRIPTION

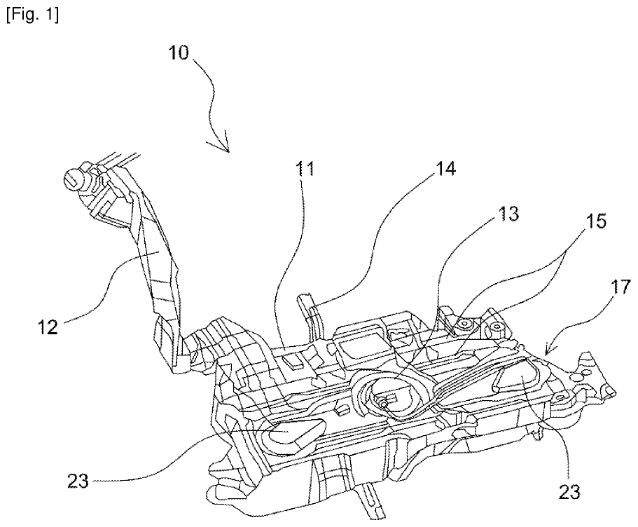

FIG. 1 shows a fuel tank 10, in particular for a motor vehicle, comprising a casing 11 preferably made of a blow-molded plastic material and which defines a fuel filling space.

A fuel filler pipe 12 proceeds from the tank 10 and terminates near an opening provided in an external panel of the body (not shown). A filler flap housing arranged in the opening of the panel is designed to receive the end of the filler pipe 12. A gauge-pump module 13 makes it possible to provide an indication of the quantity of the contents of the tank 10 and to supply the injection system of the combustion engine with fuel. The tank 10 is intended to be secured to the body of the vehicle via suitable securing means comprising, in particular, straps 14 having through-holes for securing members proceeding from the body of the vehicle, such as studs.

The casing 11 has a shape that is suitable for covering different types of motor vehicle engines. Therefore, the shape of the casing 11 may be suitable for gasoline and diesel engines without interfering with other components in the underbody of the corresponding vehicles.

In addition, the casing 11 comprises passages 15 that make shaped and adapted to route and hold pipes and/or wiring harnesses. The passages 15 are formed in advance in the casing 11 (i.e., are preformed in the casing) and are shaped and adapted to cover routes for pipes and/or wiring harnesses of different types of gasoline and diesel engines, such that some passages 15 used for the pipes and/or wiring harnesses of a gasoline engine are present for a diesel engine but not used, and vice versa. The passages 15 may for example consist of grooves made in the tank 10, the edges of which are provided with projecting portions for holding the wiring harnesses or pipes, in particular by means of snap-fitting.

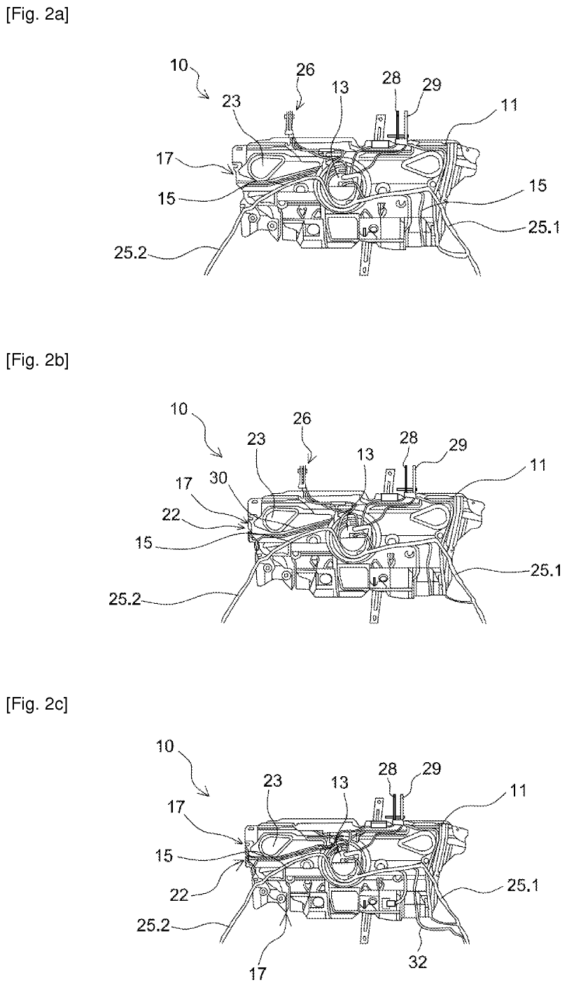

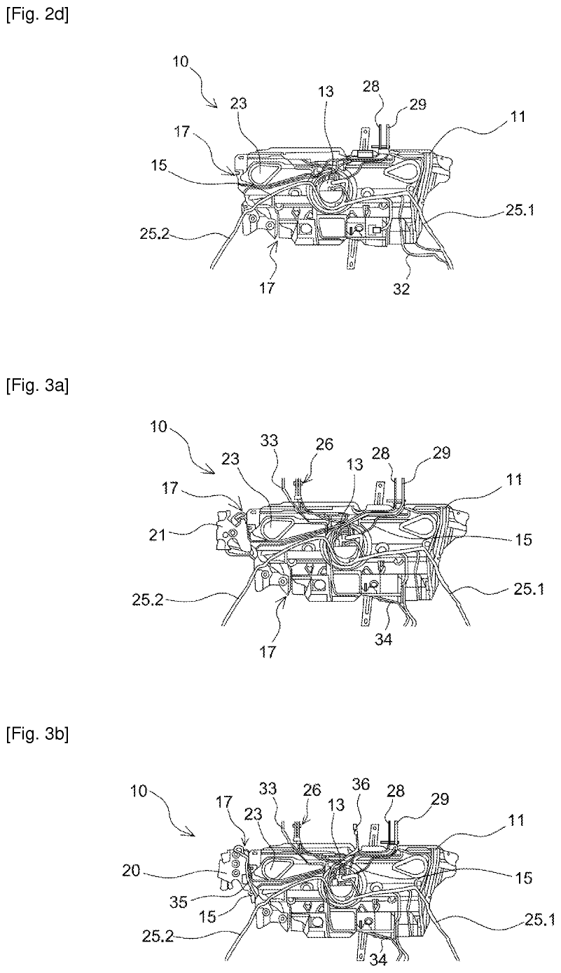

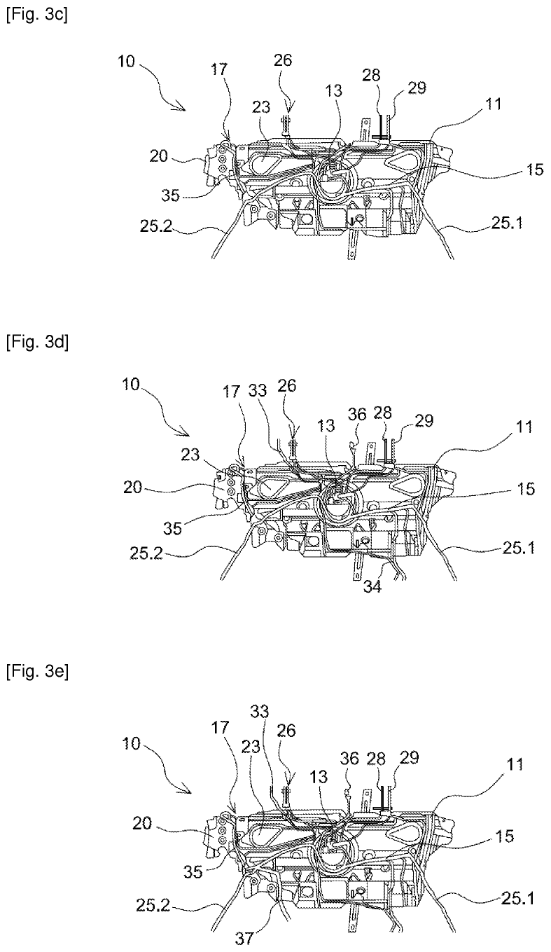

The tank 10 also comprises securing zones 17 for securing added functional modules 20-23, so as to be able to select added functional modules 20-23 depending on the type of engine of the motor vehicle. The functional module or modules added to the tank 10 are chosen from among the following functional modules: a diesel additive tank 20 (FIG. 3d), a diesel filter 21 (FIG. 3a), a gasoline filter 22 (FIG. 2b), a fuel vapor absorber (not shown), and valves 23 (FIG. 1), in particular single or bi-material valve. The fuel vapor absorber has not been shown because it is remote from the tank 10, but it could alternatively be secured to the tank 10. A valve 23 may allow venting during filling of the tank 10 or when the vehicle is operated in electric mode in order to evacuate fuel vapors. Alternatively, a valve 23 may be used to ensure recovery of the fuel vapors during filling.

The securing zones 17 dedicated to the functional modules 20-23 of a given engine are compatible with the functional modules of another engine. The term “compatible” should be understood to mean that a securing zone 17 can receive functional modules 20-23 of different engines or, at the very least, will not cause interference between functional modules of different engines. The functional modules 20-23 can be secured in the dedicated securing zones 17 via suitable securing interfaces, for example using securing members such as screws or by means of welding, in particular for securing the fuel filters.

FIGS. 2a-2d, 3a-3e, and 4 show, for different types of gasoline and diesel engines, designs of tanks 10 having a common casing 11 provided with passages 15 common to all gasoline and diesel engines as well as functional modules 20-23 that may vary from one engine to another. In other words, all the pipes and all the wiring harnesses of the different types of engines shown in the figures are intended to be received in passages 15 made in the casing 11 of the tank having a shape common to all these types of engines.

In the embodiment of FIG. 2a, which corresponds to a first gasoline engine model used for European vehicles, the tank 10 comprises passages 15 for routing and holding the rear axle wiring harnesses 25.1, 25.2, a pipe and a harness 26 for supplying an additional heating unit, as well as passages 15 for routing and holding a pipe 28 that extends from the gauge-pump module 13 to the combustion engine, and a pipe 29 that extends from a vapor absorption device to the combustion engine. It is specified that the rear axle harnesses 25.1, 25.2 each contain supply and control wires for the suspension, wheel brakes, and wheel speed sensor wire.

In the embodiment of FIG. 2b, which corresponds to a second gasoline engine model intended for export, there is also a fuel pipe 30 supplying a gasoline filter 22, which may be arranged in an associated passage 15 formed in the tank 10.

In the embodiments of FIGS. 2c and 2d, which correspond to engines intended for vehicles on the Chinese and American markets, respectively, there is also a harness 32 for supplying a leak diagnosis module of the vapor absorption device. In the embodiment of FIG. 2d, the fuel filter may be an internal filter.

In the embodiment of FIG. 3a, which corresponds to a first diesel engine model known as DV5R, the tank 10 comprises passages 15 for routing and holding the rear axle wiring harnesses 25.1, 25.2, a pipe and a harness 26 for supplying an additional heating unit, a pipe 28 extending from the gauge-pump module 13 to the combustion engine, a pipe 29 extending from a vapor absorption device to the combustion engine, a fuel pipe supplying a diesel filter 21, a diesel exhaust fluid pipe 33, and a harness 34 for supplying a pump of a selective catalytic reduction system.

In the embodiment of FIG. 3b, which corresponds to a second diesel engine model known as DV6F, there is also a diesel additive tank 20 and a corresponding pipe 35.

In the embodiment of FIG. 3c, which corresponds to a third diesel engine model known as DV6C, the pipes and harnesses of the SCR system have been omitted.

In the embodiment of FIG. 3d, which corresponds to a fourth diesel engine model of the DW10euro 6.1 or 6.2 type, there is also a harness 36 of an exhaust probe for detecting nitrogen oxide pollutants.

In the embodiment of FIG. 3e, which corresponds to a fifth diesel engine model of the DW10euro 6.3 type, there is also a harness 37 for a soot detection probe.

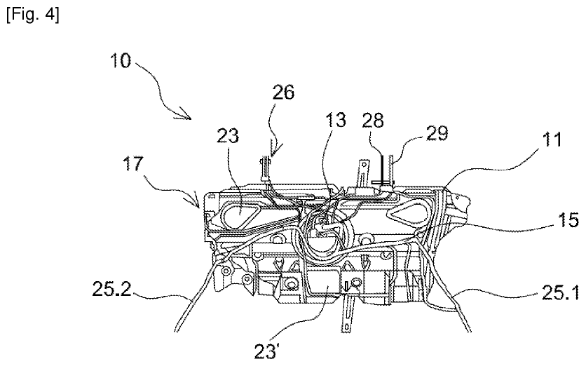

In the embodiment of FIG. 4, which corresponds to a gasoline engine model intended for the Brazilian market, the tank 10 comprises a valve 23′ for absorbing the vapors during filling of the tank 10.

1. A fuel tank adapted to be used with several types of motor vehicle engines, comprising:
a casing defining a fuel filling space,
a fuel filler pipe, and
a gauge-pump module,
wherein the casing has a shape suitable for covering different types of gasoline and diesel engines, and wherein the casing comprises passages for routing and holding pipes and/or wiring harnesses, the passages being formed in advance in the casing and being capable of covering routes for pipes and/or wiring harnesses of different types of gasoline and diesel engines, such that some of the passages used for the pipes and/or wiring harnesses of a given engine are present for an engine of another type but are not used.

2. The fuel tank according to claim 1, wherein said tank further comprises securing zones for securing added functional modules, so as to be able to select, if necessary, said added functional modules as a function of the type of engine of the motor vehicle.

3. The fuel tank according to claim 2, wherein the added functional module or modules of the tank are chosen from among the following functional modules: a diesel additive tank, a diesel filter, a gasoline filter, a fuel vapor absorber, and valves.

4. The fuel tank according to claim 1, wherein the securing zones dedicated to the functional modules of a given engine are compatible with the functional modules of another engine.

5. The fuel tank according to claim 1, wherein, in order to be compatible with a gasoline engine, said passages are adapted for routing and holding all or some of the following pipes and wiring harnesses: rear axle harnesses, a pipe and a supply harness of an additional heating unit, a pipe extending from the gauge-pump module to a combustion engine, a pipe extending from a vapor absorption device to the combustion engine, a fuel pipe supplying a gasoline filter, and a harness for supplying a leak diagnosis module of the vapor absorption device.

6. The fuel tank according to claim 1, wherein, in order to be compatible with a diesel engine, said passages are adapted for routing and holding all or some of the following pipes and wiring harnesses: rear axle harnesses, a pipe and a harness for supplying an additional heating unit, a pipe extending from the gauge-pump module to a combustion engine, a pipe extending from a vapor absorption device to the combustion engine, a fuel pipe supplying a diesel filter, a diesel exhaust fluid pipe and a harness for supplying a pump of a selective catalytic reduction system, a harness of an exhaust probe for detecting nitrogen oxide pollutants, and a harness for a soot detection probe.

7. The fuel tank according to claim 1, wherein the casing is made of a blow-molded plastic material.

8. A motor vehicle characterized in that it comprises the fuel tank of claim 1.
